(19) United States
(12) Patent Application Publication
(10) Pub. No.: US 2015/0022815 A1
(43) Pub. Date: Jan. 22, 2015

(54) Quantum Chemical Analysis

(71) Applicant: Wael Talaat Abd El-kader ISMAIL, (US)

(72) Inventor: Wael Talaat Abd El-kader Ismail, Mansoura (EG)

(21) Appl. No.: 14/129,286

(22) PCT Filed: Sep. 25, 2012
(86) PCT No.: PCT/EG2012/000029

§ 371 Date: Dec. 25, 2013

(30) Foreign Application Priority Data
Feb. 29, 2012 (EG) 2012020368

(51) Int. Cl. G01N 21/59

(52) U.S. Cl. CPC G01N 21/59; G01N 2201/0612; G01N 21/03
USPC 356/432

(57) ABSTRACT

A new trend in chemical analysis is introduced including design of new instruments used for counting of molecules and enantiomers in a given solution. The method is mainly based on quantum optics and quantum chemistry which are the reasons for the expression “Quantum Chemical Analysis”. Where a modern technology of photon counting is used. Also, the wavelength used is estimated through molecular orbital calculations. The method dose not require a raw material to construct a calibration curve. So, it can be applied for determination of compounds where their raw materials can not be provided like impurities, degradation products, biological compounds etc. In addition to the small time of analysis which allow study of kinetics of transition state.

### TECHNICAL FIELD

Analytical Chemistry

### BACKGROUND ART

1) Other analytical methods and techniques need construction of calibration curves. This process require providing of authentic materials of the analyzed compounds.

2) Other analytical methods have a certain limit of sensitivity and providing the concentration in weight/volume or molarity or others. But the proposed method can calculate the number of molecules which provides maximum sensitivity.

3) Large volume required for analysis compared with the light sample in the proposed method.

4) Other techniques can not analyze the activated complex or the transition state (due to long time of analysis).

5) Other analytical methods can not count enantiomers without separation.

### DISCLOSURE OF THE INVENTION

A new trend in chemical analysis is introduced including design of new instruments used for counting of molecules and enantiomers in a given solution. The method is mainly based on quantum optics and quantum chemistry which are the reasons for the expression “Quantum Chemical Analysis”. Modern technology of photon counting is used. Also, the wavelength used is estimated through molecular orbital calculations. The method dose not require a raw material to construct a calibration curve. So, it can be applied for determination of compounds where their raw materials can not be provided like impurities, degradation products, biological compounds etc. In addition to the small time of analysis which allow study of kinetics of transition state.

[I] Principle of Counting Molecules by Excitation

The idea of this technique depends upon irradiation of a sample with a certain attosecond laser pulse with a wavelength resonant with a certain functional group in the compound. The laser pulse photons are counted before and after passing through the sample. The number of excited populations equal to the number of absorbed photons which can be determined from the difference in the mean photon number between the incident and transmitted ones. The total number of molecules are calculated from Boltzman distribution law^{(1,2)}. Thermal equilibrium is achieved by adjusting the temperature of the sample through applying the equipartition theorem (as illustrated after). The volume of solution passed by the light beam (which contain the molecules which will be counted by Boltzman distribution law) is calculated by multiplying the cross section area of the beam by the optical path length. The estimated number of population above represents the molecules found in the volume of solution passed by the light beam. Then the total number of molecules in the whole solution is easily now to be determined.

1: Light source

2: Rotating base

3: Filter

4: Sample cell

5: Thermostatic controlled heater

6: quartez windows

7: CCD cameras

8: Read out

The instrument can be used separately or as a detector in other techniques like HPLC, LC-MS-NMR (as a third detector in addition to mass and NMR).

1. Light Source:

Sub femtosecond or isolated attosecond laser pulse is used for our study for some reasons

As our study deals with the excited state of molecule^{(2,3)}.

The interaction is between photons and electrons.

The life time of the excited state is nearly 10⁻⁸ second and the electronic transition time is 10^{-16 (1)} So the pulse duration must be less than the life time of the excited state to avoid relaxation of the molecule and reexcitation again by absorbing photons. Or emitting photons through fluorescence which will make error in photon counting. Also, the pulse duration is preferred to be equal to the electronic transition time. Sub femtosecond or isolated attosecond laser pulse can be generated with different wavelengths⁽⁴⁾. Several works have been done for production of attosecond either isolated or in trains⁽⁵⁻⁸⁾.

Type of Light:

The task of quantum optics is to study the consequences of considering the light beam as a stream of photons rather than as a classical wave. There are three types of light according to photon statistics: Poissonian, Super-poissonian and Sub-poissonian. This classification is based on the distribution of photons along the wave. Photons are randomly distributed all over the light wave. The standard deviation can be calculated for each type:

TABLE 1
different types of light according photon statistics

| Photon | Classical | Intensity | |
|---|---|---|---|
| statistics | equivalens | I(t) | Δn |
| Super- | Partially coherent (chaotic), | Time | >√n |
| poissonian | incoherent, or thermal light | varying | |
| Poissonian | Perfectly coherent light | Constant | =√n |
| Sub- | Non classical light | Constant | <√n |
| poissonian | | | |

Where η in the number of photons

I(t) is the intensity per time

Sub-poissonian light has narrow photon number distribution than for Poissonian light. Sub-poissonian light is somehow more stable than perfectly coherent light. There are several types of Sub-poissonian light. Some of them have time interval between photons in the beam are not exactly the same but still more regular than those in Poissonian light. Other types contain regular time interval between photons like photon number state and antibunched light where the standard deviation equal to zero⁽²⁾. Several papers about production of non classical light have been published⁽⁹⁻¹¹⁾.

Sub-poissonian light like laser diodes is used for our study to minimize the standard deviation.

2: Rotating Base

As the photons are counted twice before entering the sample cell and after pass through the cell. So rotating base is used to rotate the light source in two directions. The first direction to count the intial photons and the second direction to orient the light source to the sample cell.

3: Filter

It is used to select the appropriate wavelength.

4: Sample Cell:

The sample cell resemble the cuvette of spectrophotometric instrument but with 1 mm geometric path length and known volume. That is to minimize the number of molecules found in the light path. The solution should be very diluted.

5: Thermostatic Controlled Heater

The application of Boltzman distribution law require thermal equilibrium with the radiation. So equipartition theorem is applied here so that the required temperature for the thermal equilibrium is calculated.

hν=3/2 kT (equipartition theorem)

where

h: Planck constant

ν: the frequency used for excitation

k: Boltzman constant

T: the absolute temperature

Thermostatic controlled heater is used to adjust the temperature of the sample cell to get thermal equilibrium.

6: Quartz Windows

The windows is made of quartz in pass both UV and visible light.

7: Photon Counting Detector:

Photon counter consists of a very sensitive light detector such as photomultiplier (PMT) or avalanche photodiode (APD) connected to electronic counter. The detector produces shot voltage pulses in response to the light beam and the counter registers the number of pulses that are emitted within a certain time interval set by the user. Photon counter operate in a very similar way to the Geiger counter used to count the particles emitted by the decay of radioactive nuclei^{(2,12)}. Photon counting detector are specified by their quantum efficiency η, which defined by the ratio of the number of photocounts to the number of incident photons. There are modern detectors with high quantum efficiencies like photodiode and CCD camera (charge coupled device)^{(2,3,13)}. CCD camera is used in our study as it is very advanced detector produces one count for each photon⁽¹³⁾. CCD camera is provided with soft ware used also to determine the cross sectional area of the incident light beam.

8: Read Out

Read out is the number of molecules. All required soft wares like soft ware used for molecular orbital calculations, 3d Chemo office and those required to solve mathematical equations, etc are provided in one computer.

General Procedure:

The photons in the selected wavelength is firstly counted then recounted after passing through the sample. The mean difference in the photon number represents the number of excited molecules. The total number of molecules in the path way of the light is determined using Boltzman distribution law^{(1,2)}.

A. Blank Experiment:

Blank experiment is done by passing the light into an empty cell to ensure that no photons absorbed by the walls of the cell. There is no need to make blank by adding the solvent in the cell because the wavelength is selected so that it can not be absorbed by the solvent. That is due to the photon energy in UV-Visible range follows all or non rule^{(1,2)}.

B. Selection of the Wavelength:

In case that the raw material is not available, the selection of the used wavelength depend on theoretical study of the molecular structure. The wavelength (in IR, Visible, UV ranges) should be resonant with a certain functional group in the compound. Then the number of excited electrons can be estimated which are equal to the number of absorbed photons. Calculations based on semi-emprical, ab initio method, and density function theory. Modern soft wares are used to correlate the HOMO-LUMO (highest occupied molecular orbital—lowest unoccupied molecular orbital) energy gap with the wavelength of spectroscopic absorption. The tables bellow show excitation wavelengths and wavenumbers of some functional groups⁽¹⁴⁾:

TABLE 2
Excitation wavelengths of some functional groups

| Group | λₘₐₓ/nm |
|---|---|
| C═C (π → π*) | 163 |
| C═C—C═C | 217 |
| C═C—C═C—C═C | 252 |
| C═C—C═C—C═C—C═C | 304 |
| C═O (n → π*) | 174 |
| —N═N— | 350 |
| —NO₂ | 280 |
| C₆H₅— | 255 |
| [Cu(OH2)]²⁺ | 810 |
| [Cu(NH₃)₄]²⁺ | 610 |
| H₂O | 167 |

TABLE 3
Wavenumber of some functional groups

| Vibration type | Wave number (ν′/cm⁻¹) |
|---|---|
| C—H | 2850-2960 |
| C—H | 1340-1465 |
| C—C stretch, bend | 700-1250 |
| C═C stretch | 1620-1680 |
| C≡C stretch | 2100-2260 |
| O—H stretch | 3590-3650 |
| C═O stretch | 1640-1780 |
| C≡N | 2215-2275 |
| N—H stretch | 3200-3500 |

The calculation of the energy gap and hence the excitation wavelength of a certain functional group depend on the molecular structure. So the wavelengths above may have small variations depend on the surrounding molecular orbitals^{(14,15)}.

At the simplest approximation, one electron from the HOMO of an organic molecule will be promoted to LUMO⁽¹⁶⁾. In case of ethane, one electron in π bond is knocked by a photon to π* antibonding orbital⁽¹⁷⁾. Also, in case of C═O excitation, one electron of the unshared pairs (non bonding n electrons) is promoted to high energy level⁽¹⁸⁾. The energy gaps have been estimated of many compounds such as nevirapine⁽¹⁹⁾, 1,2-dichloro-4-nitrobenzene⁽²⁰⁾, yohimbine hydrochloride⁽²¹⁾, oligo-4-[(2hydroxybenzylidene)amino]benzoic acid⁽²²⁾, glucocorticoids⁽²³⁾.

C: Achieving Thermal Equilibrium

Thermal equilibrium is achieved by adjustment of the temperature of the sample. Equipartion theorem is applied to calculate the temperature required for thermal equilibrium.

hν=3/2kT (equipartition theorem)

where

h: Planck constant

ν: the frequency used for excitation

k: Boltzman constant

T: the absolute temperature

D: Light Sampling

The expression light sampling is due to determination of the number of molecules in the volume of solution passed by the light beam. As if the light take a sample volume from the solution in the cell.

Approximation:

An approximation can be introduced here for the consideration of the volume containing the counted molecules. This approximation is analog to Born Oppenheimer approximation⁽¹⁴⁾. Based on Einstein postulates of relativity, there are nothing can move faster than light. Also, by considering the photon as massless particle or have a gravitational mass of hν/C² Where h is Plank constant=6.626×10⁻³⁴ J.S, ν is the frequency and C in the light speed=3×108 ^{(24,25)}. The mass of any molecule is very large compared to photon, hence the molecule move very slowly compared to photon speed. So the molecules in the solution can be considered stationary during the passage of light pulse through the solution.

Optical Path:

The propagation of light is in a straight line but the photon motion in the wave has different manner of rotating and revolving movement⁽²⁶⁾. To determine the distance traveled by light in a medium, the optical path length is considered⁽²⁷⁾.

Δ=fd

Δ: optical path length

f: refractive index

d: geometric path length

Adjustment of Beam Diameter:

The laser beam radius or diameter is practically measured. CCD beam profiler's software computes the knife-edge width numerically⁽¹³⁾. The beam may have circular or elliptical cross section. If it is elliptical, the major and minor diameter are measured. The diameter of the beam is adjusted to the scale of the molecule. The scale of molecule is determined by soft wares like 3D chem draw program. So that the area of the beam will equal or multiple of the molecule scale.

Determination of the Volume of Solution Containing the Counted Molecules:

If the beam cross section is circular, where r is the radius of the beam. The volume V can be calculated as follows:

V=πr²fd

If the beam cross section is elliptical where a, b are the major and minor radii. The volume V can be calculated as follows:

V=πabfd

Calculation of the Number of Molecules:

The number of molecules (N) in the calculated volume (V) can be determined by application of Boltzman distribution law^{(1,2)}:

N₁/N₂=e^{-hν/kT}

N=N₁+N₂

Where

N: Total number of molecules in the volume (V)

N₁, N₂: The number of population in excited and ground state respectively.

h: Planck constant

ν: frequency of excitation

k: Boltzman constant

T: absolute temperature

Now the number of molecule can be calculated in the whole volume of the sample.

[II] Counting of Molecules by Ionization:

This technique is the same as the above one but the difference is in the choice of the wavelength. The wavelength selected is resonant with ionization energy of a certain group within the molecule as in the technique of REMPI (Resonant Enhanced Multi Photon Ionization)⁽³⁾. The librated electrons can be counted by electric counter. The number of librated electrons equal to the excited molecules. Vacuum is applied here to get the sample in the gaseous state. The procedure is continued as above.

1: Light source

2: Filter

3: Quartez window

4: Sample cell

5: Vacuum system

Vacuum system (of known volume) is applied to withdraw the sample and get the sample in the gaseous state.

6: Thermostatic controlled heater

7: Electron counter

8: Read out

9: Pathway of the light beam which is away from the electric counter

[3] Counting of Enantiomers

The light polarization may be plane polarization or circular polarization. The circular polarization involve rotation of electric and magnetic fields around the direction of propagation in either clockwise or counterclockwise sense but remain perpendicular to it and each other. Chiral molecules absorb right and left circular polarized light to different extent⁽¹⁴⁾. This property is utilized to count enantiomers in a given solution by introducing right or left circular polarized light in the instrument. The instrument used here is like that in FIG. 1 but the light source produces circular polarized light. The procedure is continued as above.

Advantages of These Techniques

1) There is no need of authentic sample to construct a calibration curve. So, can be utilized for analysis of impurities, degradation products, biological compounds.

2) Very small sample volume required for the analysis (light sample).

3) Analysis of mixtures of compounds can be done either by selecting a wavelength where no interference is encountered or by separating techniques like HPLC, LC-MS-NMR and use the instrument as a detector.

4) Analysis of very weak UV absorbing compounds (once the compound absorb, it can be determined).

5) Very sensitive in trace analysis.

6) Very small standard deviation (SD≈0).

7) Enantiomers can be counted without separation.

8) Studying of bioavailability of drugs in very small dose. Where some drugs are administered in micrograms

9) Very small time of analysis. As the analysis should be done in a time less than life time of excited state and equal to electronic transition time. This advantage allow the study of kinetics of transition state. Through verification of Eyring equation, determination of the concentration of the activated complex and the rate of its formation and decay.

10) Study the kinetics and the mechanism of disease: The disease can be considered as a chemical reaction. Hence determination of rate and rate constant of it provide information for the drug design. The drug reaction rate and rate constant should be larger than that of the disease. Also, the time for the formation of transition state of the drug reaction should be shorter than that of the disease.

### REFERENCES

(1) Robert Eisberg, Robert Resnick “Quantum Physics” USA 1985.

(2) Mark Fox “ Quantum Optics” Oxford University Press 2007.

(3) Helmut H. Telle, Angel Gonzalez Urena, Robert J. Donovan “Laser Chemistry”John Wiley &sons Ltd, The Atrium, Southern Gate, Chichester, westSussex PO 19 8SQ, England 2007.

(4) Pierre Agostini, Louis F DiMauro” The physics of attosecond light pulses” Rep. Prog. Phys. (67) 813. 2004

(5) Schultze, M; Wirth, A.; Grguras, I.; Uiberacker, M.; Uphues, T.; Verhoef, A. J.; Gagnon, J.; Hofstetter, M.; Kleineberg, U.; Goulielmakis, E.; Krausz, F. “State-of-the-art_attosecond metrology” Journal of Electron Spectroscopy and Related Phenomena, (184), Issues 3-6. 2011

(6) Nisoli, M.; Sansone, G. “ New frontiers in attosecondscience” Progress in Quantum Electronics, (33), Issue 1, 2009

(7) Tzallas, P.; Tsakiris, G. D.; Witte, K.; Nikolopoulos, L. A. A.; Benis, E. P.; Charalambidis, D. “The_attosecond-science frontiers: generation, metrology and paths to applications” Journal of Electron Spectroscopy and Related Phenomena, (144-147) 2005

(8) Nazarkin, A.; Korn, G.; Elsaesser, T. “All-linear control of attosecond pulse generation “Optics Communications, Volume 203, Issues 3-6, 15 Mar. 2002

(9) Edo Waksl, Eleni Diamantil and Yoshihisa Yamamoto “Generation of photon number states” New Journal of Physics 8. 2006.

(10) Keller M, Lange B, Hayasaka K, Lange W, Walther H” Continuous generation of single photons with controlled waveform in an ion-trap cavity system” Nature 431(7012). 2004.

(11) Varcoe B T, Brattke S, Weidinger M, Walther H.” Preparing pure photon number states of the radiation field” Nature. 403(6771). 2000.

(12) Douglas A. Skoog, James F. Holler, Stanley R. Crouch “Principles of instrumental Analysis”6^{th} edition. USA 2007.

(13) The Wikipedia www.en.wikipedia.org

(14) Peter Atkins, Julio de Paula “Elements on Physical Chemisty” 9^{th}, Oxford University Press 2010

(15) Errol Lewars “Computational Chemistry” New York 2006

(16) Neil S.ISAACS “Physical Organic Chemistry” London, UK 1990

(17) Philip Matthews “Advanced Chemistry” Cambridge University Press, UK 1996

(18) Graham Solomons T. W.“Organic Chemistry” 6^{th} USA 1996

(19) Govindaswamy, R; Shanmugam, S; Thirumazhisai, J; Sethu, G; Julie, C; Jayaprakash, R“Molecular structure, vibrational spectra, UV-vis, NBO, and NMR analyses on nevirapine using ab initio DFT methods” Journal of Theoretical and Applied Physics 7:51. 2013

(20) Arivazhagan, M.; Jeyavijayan, S. “Vibrational spectroscopic, first-order hyperpolarizability and HOMO, LUMO studies of 1,2-dichloro-4 nitro benzene based on Hartree-Fock and DFT calculations” Spectrochimica Acta Part A 79 .2011.

(21) Bhawani Datt Joshi; Anubha Srivastavaa; Poonam Tandona; Sudha Jain “Molecular structure, vibrational spectra and HOMO, LUMO analysis of yohimbine hydrochloride by density functional theory and ab initio Hartree-Fock calculations” Spectrochimica Acta Part A .2011.

(22) Ismet Kayaa; Ali Bilici “Synthesis, characterization, thermal stability, conductivity and band gap of oligo-4-[(2hydroxybenzylidene)amino]benzoic acid” Synthetic Metals 156 .2006.

(23) Kubli-Garfias, C.; Va´zquez-Ramírez, R.“Ab initio calculations of the electronic structure of glucocorticoids” Journal of Molecular Structure (Theochem) 454 .1998

(24) Arthur Beiser “Concepts of Modern Physics” 6^{th} India 2005

(25) Ta-Pei Cheng “Relativity, Gravitation and Cosmology” Oxford University Press 2006

(26) Chaim Tejman “Grand unified Theory Wave theory” throught internet www.grandunifiedtheory.org.il

(27) Francis A Jenkind, Harvey E. Whitr “Fundamentals of Optics” 4^{th} Singapore 1985

1. Instrument claim
a) Counting of Molecules by Excitation
The idea of this technique depends upon irradiation of a sample with a certain attosecond laser pulse with a wavelength resonant with a certain functional group in the compound. The laser pulse photons are counted before and after passing through the sample. The number of excited populations equal to the number of absorbed photons which can be determined from the difference in the mean photon number between the incident and transmitted ones. The total number of molecules are calculated from Boltzman distribution law^{(1,2)}. Thermal equilibrium is achieved by adjusting the temperature of the sample through applying the equipartition theorem (as illustrated after). The volume of solution passed by the light beam(which contain the molecules which will be counted by Boltzman distribution law) is calculated by multiplying the cross section area of the beam by the optical path length. The estimated number of population above represents the molecules found in the volume of solution passed by the light beam. Then the total number of molecules in the whole solution is easily now to be determined.
1: Light source
2: Rotating base
3: Sample cell
4: Thermostatic controlled heater
5: CCD camera
6: Read out
1. Light Source:
Sub femtosecond or isolated attosecond laser pulse is used in our study.
Type of Light:
Sub-poissonian light like laser diodes is used in our study to minimize the standard deviation.
2: Rotating Base
As the photons are counted twice before entering the sample cell and after pass through the cell. So rotating base is used to rotate the light source in two directions. The first direction to count the intial photons and the second direction to orient the light source to the sample cell.
3: Sample Cell:
The sample cell resemble the cuvette of spectrophotometric instrument but with 1 mm geometric path length and known volume. That is to minimize the number of molecules found in the light path. The solution should be very diluted.
4: Thermostatic Controlled Heater
Thermostatic controlled heater is used to adjust the temperature of the sample cell to get thermal equilibrium.
5: CCD Camera:
CCD camera (charge coupled device), is used in our study to count photons as it is very advanced detector produces one count for each photon. CCD camera is provided with soft ware used also to determine the cross sectional area of the incident light beam.
6: Read Out
Read out is the number of molecules. All required soft wares like soft ware used for molecular orbital calculations, 3d Chemo office and those required to solve mathematical equations, etc are provided in one computer.
b) Counting of Molecules by Ionization
This technique is the same as the above one but the difference is in the choice of the wavelength. The wavelength selected is resonant with ionization energy of a certain group within the molecule as in the technique of REMPI (Resonant Enhanced Multi Photon Ionization). The librated electrons can be counted by electric counter. The number of librated electrons equal to the excited molecules. Vacuum is applied here to withdraw the sample and get the sample in the gaseous state.
1: Vacuum system
Vacuum system (of known volume) is applied to withdraw the sample and get the sample in the gaseous state.
2: Electric counter
c) Counting of Enantiomers
1) light source: produces circular polarized light

2. Method claim:
The photons in the selected wavelength is firstly counted then recounted after passing through the sample. The mean difference in the photon number represents the number of excited molecules. The total number of molecules in the path way of the light can be determined using Boltzman distribution law^{(1,2)}.
A. Blank Experiment:
Blank experiment is done by passing the light into an empty cell to ensure that no photons absorbed by the walls of the cell. There is no need to make blank by adding the solvent in the cell because the wavelength is selected so that it can not be absorbed by the solvent. That is due to the photon energy in UV-Visible range follows all or non rule.
B. Selection of the Wavelength:
In case that the raw material is not available, the selection of the used wavelength depend on theoretical study of the molecular structure. The wavelength (in IR, Visible, UV ranges) should be resonant with a certain functional group in the compound. Then the number of excited electrons can be estimated which are equal to the number of absorbed photons. Calculations based on semi-emprical, ab initio method, and density function theory. Modern soft wares are used to correlate the HOMO-LUMO (highest occupied molecular orbital—lowest unoccupied molecular orbital) energy gap with the wavelength of spectroscopic absorption.
C: Achieving Thermal Equilibrium
Thermal equilibrium is achieved by adjustment of the temperature of the sample. Equipartion theorem is applied to calculate the temperature required for thermal equilibrium.
hν=3/2kT (equipartition theorem)
where
h: Planck constant
ν: the frequency used for excitation
k: Boltzman constant
T: the absolute temperature
D: Light Sampling
The expression light sampling is due to determination of the number of molecules in the volume of solution passed by the light beam. As if the light take a sample volume from the solution in the cell.
Approximation:
An approximation can be introduced here for the consideration of the volume containing the counted molecules. This approximation is analog to Born Oppenheimer approximation⁽¹⁴⁾. Based on Einstein postulates of relativity, there are nothing can move faster that light. Also, by considering the photon as massless particle or have a gravitational mass of hν/C² Where h is Plank constant=6.626×10⁻³⁴ J.S, ν is the frequency and C in the light speed=3×10⁸. The mass of any molecule is very large compared to photon, hence the molecule move very slowly compared to photon speed. So the molecules in the solution can be considered stationary during the passage of light pulse through the solution.
Optical Path:
The propagation of light is in a straight line but the photon motion in the wave has different manner of rotating and revolving movement. To determine the distance travelled by light in a medium, the optical path length is considered⁽²⁷⁾.
Δ=fd
Δ: optical path length
f: refractive index
d: geometric path length
Adjustment of Beam Diameter:
The laser beam radius or diameter can be practically measured. CCD beam profiler's software can compute the knife-edge width numerically. The beam may have circular or elliptical cross section. If it is elliptical, the major and minor diameter are measured. The diameter of the beam is adjusted to the scale of the molecule. The scale of molecule is determined by soft wares like 3D chem draw program. So that the area of the beam will equal or multiple of the molecule scale.
Determination of the Volume of Solution Containing the Counted Molecules:
If the beam cross section is circular, where r is the radius of the beam. The volume V can be calculated as follows:
V=πr²fd
If the beam cross section is elliptical where a, b are the major and minor radii. The volume V can be calculated as follows:
V=πabfd
Calculation of the Number of Molecules:
The number of molecules (N) in the calculated volume (V) can be determined by application of Boltzman distribution law:
N₁/N₂e^{-hν/kT}
N=N₁+N₂
Where
N: Total number of molecules in the volume (V)
N₁, N₂: The number of population in excited and ground state respectively.
h: Planck constant
ν: frequency of excitation
k: Boltzman constant
T: absolute temperature
